(19) United States
(12) Patent Application Publication
(10) Pub. No.: US 2025/0197070 A1
(43) Pub. Date: Jun. 19, 2025

(54) CONTAINER WITH FEEDBACK

(71) Applicant: SEED HEALTH INC., Venice, CA (US)

(72) Inventors: Ara KATZ, Venice, CA (US); Raja DHIR, Venice, CA (US); Yuji SAKUMA, Venice, CA (US); Chelsea BELOFF, Venice, CA (US)

(21) Appl. No.: 18/848,450

(22) PCT Filed: Mar. 22, 2023
(86) PCT No.: PCT/US2023/064804

§ 371 Date: Sep. 18, 2024

Related U.S. Application Data
(60) Provisional application No. 63/323,008, filed on Mar. 23, 2022.

(51) Int. Cl. B65D 43/02; B65D 51/24

(52) U.S. Cl. CPC B65D 43/0212; B65D 51/248; B65D 2203/12; B65D 2543/0062; B65D 2543/00731

(57) ABSTRACT

A container with feedback is provided. The container may comprise a cap comprising a first feedback feature and a receptacle comprising a second feedback feature configured to engage with the first feedback feature. The first feedback feature and the second feedback feature may provide feedback when engaged. The cap may also comprise a set of first indicia and the receptable may comprise a second indicia.

### CROSS-REFERENCE TO RELATED APPLICATION

This application claims the benefit of U.S. Provisional Patent Application Ser. No. 63/323,008, filed Mar. 23, 2022, the entire disclosure of which is hereby incorporated herein by reference.

### FIELD OF INVENTION

The present disclosure is generally directed to containers, and relates more particularly to containers configured to provide feedback.

### BACKGROUND

Supplements and/or medication are taken daily by a variety of users. Children, in particular, may have trouble remembering to take a daily supplement and/or medication and may miss a dosage. Conventional containers are easily forgotten by users such as children and are typically used to simply store items such as supplements and/or medication.

### BRIEF SUMMARY

Example aspects of the present disclosure include:

A container according to one embodiment of the present disclosure comprises: a cap comprising a first feedback feature; and a receptacle comprising a second feedback feature configured to engage with the first feedback feature, wherein the first feedback feature and the second feedback feature provide feedback when engaged.

Any of the aspects herein, wherein the cap comprises a first body having a first cavity, the first cavity having an inner surface defining a first circumference, wherein the first feedback feature comprises at least one depression disposed on the inner surface.

Any of the aspects herein, wherein the receptacle comprises a second body having a second cavity, the second body having an outer surface defining a second circumference, wherein the second feedback feature comprises at least one protrusion disposed on the outer surface, the at least one protrusion receivable by the at least one depression.

Any of the aspects herein, wherein the at least one depression comprises a plurality of depressions positioned along the first circumference.

Any of the aspects herein, wherein the plurality of depressions comprises at least seven depressions.

Any of the aspects herein, wherein the first body and the second body are each cylindrical.

Any of the aspects herein, wherein each of the at least one depression comprises a wave having a crest and a trough, and wherein the at least one protrusion is received in the crest.

Any of the aspects herein, wherein the first feedback feature further comprises a depression ring, and wherein each wave is connected to an adjacent wave via the depression ring.

Any of the aspects herein, wherein each of the at least one depression comprises a circular depression.

Any of the aspects herein, wherein the cap and the receptacle are configured to receive a force to move the protrusion from a first depression of the at least one depression to an adjacent depression.

Any of the aspects herein, wherein the feedback comprises at least one of tactile feedback or audible feedback.

Any of the aspects herein, wherein the feedback comprises tactile feedback and audible feedback.

Any of the aspects herein, wherein the cap comprises an outer surface and a set of first indicia disposed on the outer surface, wherein the set of first indicia aligns with the at least one depression, and wherein the receptacle comprises an outer surface and a second indicia disposed on the outer surface, and wherein the second indicia aligns with the second feedback feature.

A container according to one embodiment of the present disclosure comprises: a cap comprising a first feedback feature, the cap comprising a first body having an inner surface and a first circumference, the first feedback feature comprising a plurality of circular depressions positioned on the inner surface along the first circumference; and a receptacle comprising a second feedback feature configured to engage with the first feedback feature, the receptacle comprising a second body having an outer surface and a second circumference, the second feedback feature comprising a protrusion positioned on the outer surface and along the second circumference, wherein the first feedback feature and the second feedback feature provide feedback when the protrusion engages one of the plurality of circular depressions.

Any of the aspects herein, wherein the cap and the receptacle are configured to receive a rotational force to move the protrusion from a first circular depression to an adjacent circular depression.

Any of the aspects herein, wherein the plurality of circular depressions comprises seven circular depression.

Any of the aspects herein, wherein the cap comprises a cap protrusion and the receptacle comprises a lip configured to receive the cap protrusion, and wherein the cap and the receptacle are secured to each other when the cap protrusion is received by the lip.

A method for tracking according to one embodiment of the present disclosure comprises: storing one or more contents in a container comprising a cap and a receptacle, the cap comprising an outer surface, an inner surface, a first feedback feature positioned on the inner surface, and a set of first indicia disposed on the outer surface, the first feedback feature comprising at least one depression, each of the at least one depression aligns with each of the set of first indicia, the receptacle comprising a second feedback feature configured to engage with the first feedback feature and a second indicia, the second feedback feature comprising a protrusion configured to engage one of the at least one depression, the protrusion aligns with the second indicia, wherein the second indicia aligns with one of the set of first indicia; and receiving a force by the cap to rotate the cap relative to the receptacle, wherein rotation of the cap moves the protrusion from engagement with one of the at least one depression to engagement with an adjacent one of the at least one depression and moves the second indicia from alignment with one of the set of first indicia to an adjacent one of the set of first indicia.

Any of the aspects herein, wherein engagement of the protrusion with the adjacent one of the at least one depression provides feedback.

Any of the aspects herein, wherein the feedback comprises at least one of tactile feedback or audible feedback.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, contents, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE SEVERAL VIEWS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is an isometric view of a container according to at least one embodiment of the present disclosure;

FIG. 2 is an isometric view of a cap and a receptacle separated according to at least one embodiment of the present disclosure;

FIG. 3A is a top view of a cap according to at least one embodiment of the present disclosure;

FIG. 3B is a side cross-sectional view of the cap of FIG. 3A taken along B-B according to at least one embodiment of the present disclosure;

FIG. 4A is a top view of a receptacle according to at least one embodiment of the present disclosure;

FIG. 4B is a side cross-sectional view of the receptacle of FIG. 4A taken along C-C according to at least one embodiment of the present disclosure;

FIG. 5A is a side cross-sectional view of the container of FIG. 1 taken along A-A according to at least one embodiment of the present disclosure;

FIG. 5B is a side cross-sectional view of the container of FIG. 5A at Detail A according to at least one embodiment of the present disclosure;

FIG. 5C is a side cross-sectional view of the container of FIG. 5A at Detail B according to at least one embodiment of the present disclosure;

FIG. 6 is an isometric view of a container according to at least one embodiment of the present disclosure;

FIG. 7 is an isometric view of a cap and a receptacle separated according to at least one embodiment of the present disclosure;

FIG. 8A is a top view of a cap according to at least one embodiment of the present disclosure;

FIG. 8B is a side cross-sectional view of the cap of FIG. 8A taken along E-E according to at least one embodiment of the present disclosure;

FIG. 9A is a top view of a receptacle according to at least one embodiment of the present disclosure;

FIG. 9B is a side cross-sectional view of the receptacle of FIG. 9A taken along F-F according to at least one embodiment of the present disclosure;

FIG. 10A is a side cross-sectional view of the container of FIG. 6 taken along D-D according to at least one embodiment of the present disclosure;

FIG. 10B is a side cross-sectional view of the container of FIG. 10A at Detail C according to at least one embodiment of the present disclosure;

FIG. 11 is an isometric view of a container according to at least one embodiment of the present disclosure;

FIG. 12 is an isometric view of a cap and a receptacle separated according to at least one embodiment of the present disclosure;

FIG. 13A is a side cross-sectional view of the container of FIG. 11 taken along G-G according to at least one embodiment of the present disclosure;

FIG. 13B is a side cross-sectional view of the container of FIG. 13A at Detail D according to at least one embodiment of the present disclosure;

FIG. 14A is a front view of the container of FIG. 11 according to at least one embodiment of the present disclosure;

FIG. 14B is a rear view of the container of FIG. 11 according to at least one embodiment of the present disclosure; and

FIG. 15 is a flowchart according to at least one embodiment of the present disclosure.

### DETAILED DESCRIPTION

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device and/or a medical device.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

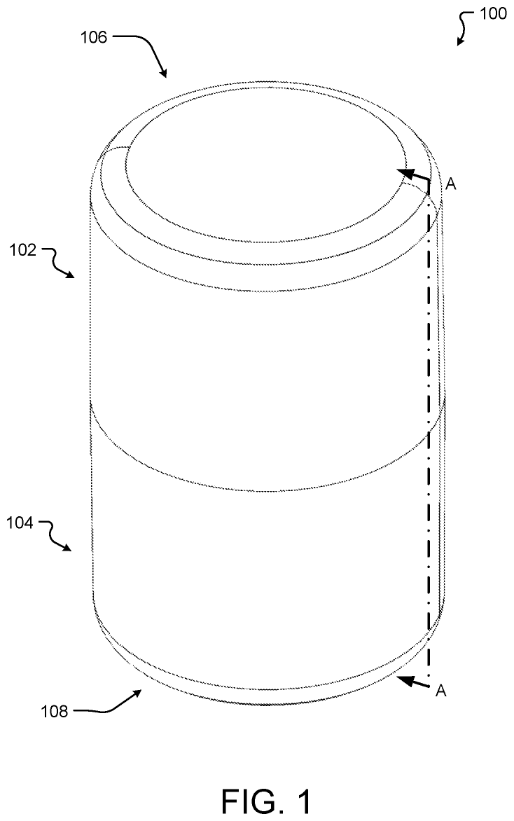

Turning first to FIG. 1, an isometric view of a container 100 is shown. The container 100 is configured to provide feedback when a cap 102 of the container 100 is moved relative to a receptacle 104 of the container 100. In particular, the feedback is provided when the cap 102 receives a force to move the cap 102 vertically and rotationally relative to the receptacle 104. The feedback may be, for example, tactile, audible, and/or visible feedback. Such feedback may be useful, for example, in providing feedback to a user such as a child to aid the child in remembering to return to the container 100. In the illustrated embodiment, the container 100 (when the cap 102 and the receptacle 104 are coupled) is cylindrical and both a first end 106 and a second end 108 of the container 100 is enclosed. It will be appreciated that in other embodiments, the container 100 may be any shape and/or size. For example, the container 100 may be spherical, rectangular, or oval.

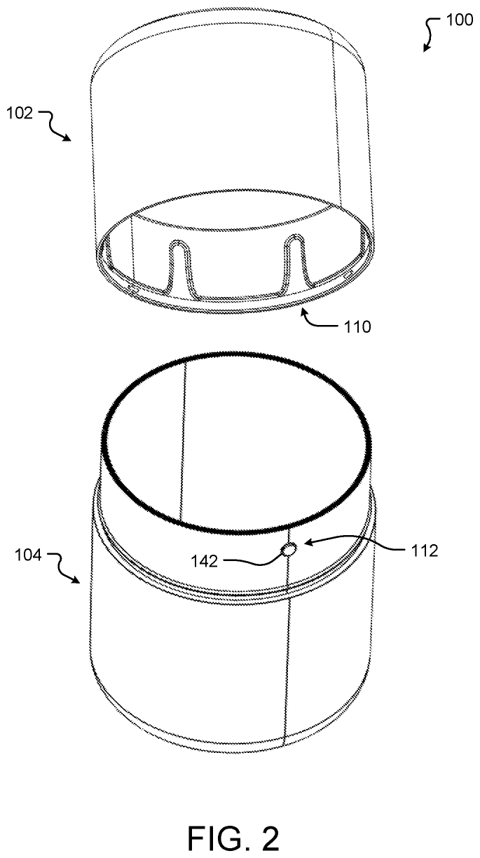

Turning to FIG. 2, the container 100 is shown with the cap 102 and the receptacle 104 separated. The cap 102 and the receptacle 104 may be formed from any material such as, but not limited to, plastic, metal, steel, aluminum, any resilient material, any flexible material, or the like. In some embodiments the cap 102 and the receptacle 104 are formed from the same material. In other embodiments, the cap 102 and the receptacle 104 are formed from different materials. The cap 102 comprises a first feedback feature 110 and the receptacle 104 comprises a second feedback feature 112 configured to engage with the first feedback feature 110. Feedback is provided when the first feedback feature 110 and the second feedback feature 112 engage. It will be appreciated that the cap 102 and/or the receptacle 104 may comprise additional feedback features. Further, the cap 102 and/or the receptacle 104 may provide more than one type of feedback. For example, the first feedback feature 110 and the second feedback feature 112 may provide a tactile and/or audible feedback. In the same example, the cap 102 and/or the receptacle 104 may comprise a third feedback feature configured to provide visual feedback (e.g., a display that changes, a marker on the cap 102 that rotates relative to the receptacle 104, etc.).

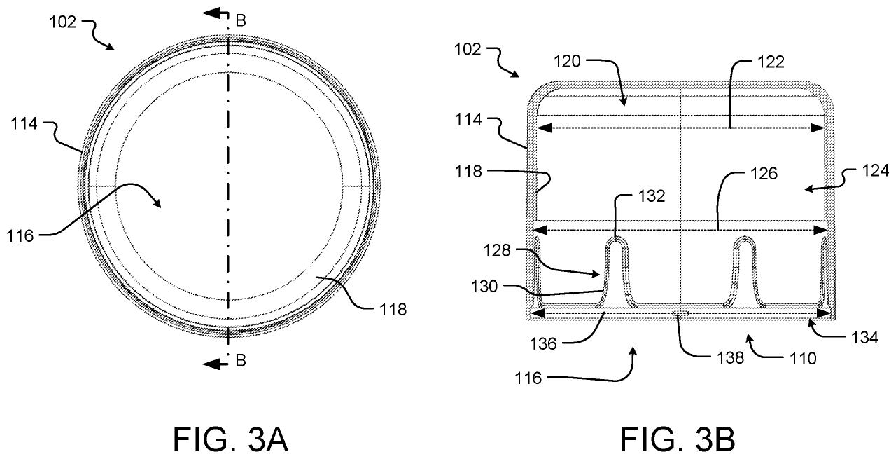

Turning to FIGS. 3A-3B, a top view of the cap 102 and a side cross-sectional side view of the cap 102 taken along line B-B of FIG. 3A are respectively shown. The cap 102 comprises a first body 114 having a first cavity 116. The first body 114 is cylindrical in the illustrated embodiment, though it will be appreciated that the first body 114 may be any shape. The first cavity 116 includes an inner surface 118 and a first circumference. The first cavity 116 also has a first portion 120 having a first diameter 122, a second portion 124 having a second diameter 126. The first diameter 122 is less than the second diameter 126. The first portion 120 forms a volume by which to receive and/or store items (in combination with the receptacle 104). The second portion 124 is sized to receive a receiver portion 140 of the receptacle 104.

The first feedback feature 110 comprises at least one depression 128 disposed on the inner surface 118 and in the second portion 124. More specifically, the at least one depression 128 may comprise a plurality of depressions 128 positioned along the first circumference. In the illustrated embodiment, the at least one depression 128 comprises seven depressions. It will be appreciated that in some embodiments, the at least one depression 128 comprises more than or less than seven depressions. In the illustrated embodiment, the seven depressions are spaced equidistance around the first circumference. In other embodiments, the seven depressions (or any number of depressions) may not be spaced equidistance around the first circumference and may be spaced anywhere on the cap 102. As shown in the illustrated embodiment, each depression of the at least one depression 128 comprises a wave 130 having a crest 132 and the first feedback feature 110 further comprises a depression ring 134 having a third diameter 136.

The third diameter 136 is greater than the second diameter 126. In the illustrated embodiment, the cap 102 includes seven waves and each wave is connected to an adjacent wave via the depression ring 134. It will be appreciated in other embodiments that the cap 102 may include less than or more than seven waves. As will be described in detail below, the at least one depression 128 (e.g., waves) is configured to receive a protrusion 142 of the receptacle 104 and movement of the protrusion 142 from a first depression (e.g., a first wave) to an adjacent depression (e.g., an adjacent wave) provides feedback to a user. In embodiments where the at least one depression 128 comprises seven depressions, the seven depressions may correlate to seven days of the week.

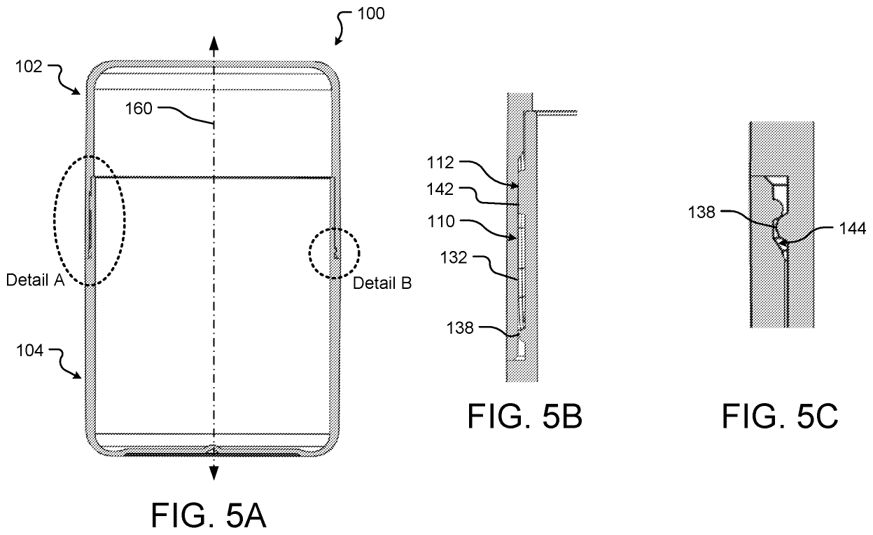

The cap 102 may also comprise at least one cap protrusion 138 disposed on the inner surface 118 and (visible in FIGS. 2 and 5A-5C) configured to be received by a groove 144 (visible in FIGS. 2, 4B, and 5A-5C) of the receptacle 104. The cap 102 may be secured to the receptacle 104 when the at least one cap protrusion 138 is received by the groove 144. In the illustrated embodiment, the at least one cap protrusion 138 comprises three cap protrusions, though in other embodiments, the at least one cap protrusion 138 may comprise more than or less than three cap protrusions. It will be appreciated that in other embodiments, the cap 102 and the receptacle 104 may be secured to each other using other forms of securement. For example, as described in detail with respect to a container 200 below, the cap 102 and the receptacle 104 may be secured to each other using a gasket and a press fit. In other examples, the cap 102 and the receptacle 104 may be secured to each other using a press fit, a snap fit, or the like.

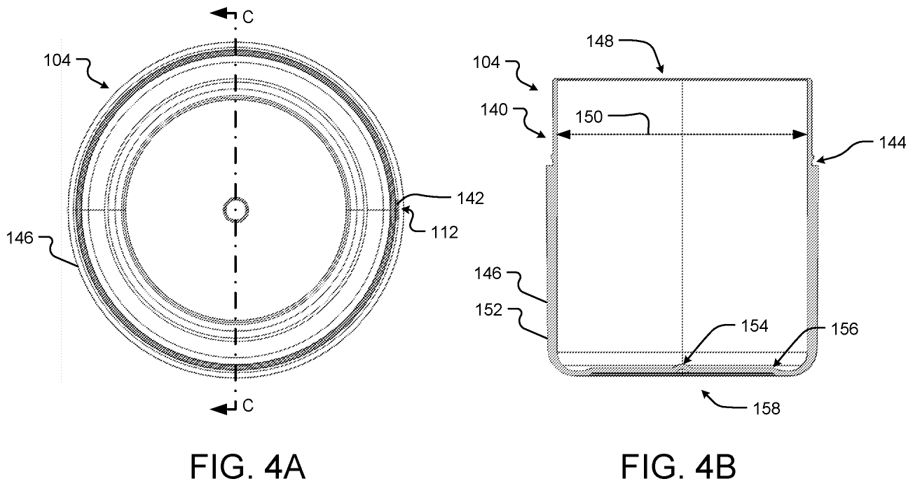

Turning to FIGS. 4A-4B, a top view of the receptacle 104 and a side cross-sectional side view of the receptacle 104 taken along line C-C of FIG. 4A are respectively shown. The receptacle 104 comprises a second body 146 having a second cavity 148. The second body 146 is cylindrical in the illustrated embodiment, though it will be appreciated that the second body 146 may be any shape. The second cavity 148 defines a fourth diameter 150 substantially equal to the first diameter 122. In other instances, the fourth diameter 150 may be less than or greater than the first diameter 122. The second cavity 148 and the first cavity 116 are configured to receive and/or store items such as, for example, supplements, medications, or the like.

The second body 146 comprises the receiver portion 140 which is configured to be received by the second portion 124 of the cap 102. The second body 146 also comprises an outer surface 152 defining a second circumference and at least one protrusion 142 (also visible in FIGS. 2, 5A, and 5B) disposed on the outer surface 152. The at least one protrusion 142 is also disposed on the receiver portion 140. As previously described, the at least one protrusion 142 is receivable by the at least one depression 128. The receiver portion 140 also comprises the groove 144, which is configured to receive the at least one cap protrusion 138. In the illustrated embodiment, the second body 146 comprises a center protrusion 154 and raised portion 156 at a bottom 158 of the second body 146. It will be appreciated that in other embodiments, the second body 146 may not include the center protrusion 154 and/or the raised portion 156 and the second body 146 may have a flat surface at the bottom 158, or may have a surface of any shape.

Turning to FIGS. 5A-5C, a side cross-sectional side view of the container 100 taken from line A-A shown in FIG. 1, Detail A of the side cross-sectional side view of the container 100, and Detail B of the side cross-sectional side view of the container 100 are respectively shown. More specifically, FIG. 5B illustrates the at least one protrusion 142 received by the at least one depression 128 and FIG. 5C illustrates the at least one cap protrusion 138 received by the groove 144 of the receptacle 104.

The cap 102 and the receptacle 104 are configured to receive a force to move the at least one protrusion 142 from a first depression of the at least one depression 128 to an adjacent depression. More specifically, in embodiments where the at least one depression 128 comprises waves 130, the at least one protrusion 142 is received by the crest 132 of the wave 130. To move the at least one protrusion 142 from a crest 132 of a first wave 130 to a crest 132 of a second, adjacent wave 130, the cap 102 is vertically moved along the axis 160 (which may be, for example, a center axis) away from the receptacle 104 until the at least one protrusion 142 is positioned at least the depression ring 134 or past the depression ring 134. The cap 102 is then rotated around the axis 160 until the at least one protrusion 142 is aligned with any portion of the second, adjacent wave 130 and moved vertically along the axis 160 towards the receptacle 104. The at least one protrusion 142 follows or is guided by a profile of the second, adjacent wave 130 until the at least one protrusion 142 is positioned in a crest 132 of the second, adjacent wave 130. Such movement of the cap 102 and the receptacle 104 provides feedback to a user such as, for example, a child. The feedback may help the child to remember to return to the container 100 each day, or as needed, for the child's supplement and/or medication. Further, in embodiments where the at least one depression 128 comprises seven waves 130, each wave 130 may be associated with a day of the week. In some embodiments, a visual feedback such as, for example, the day of the week may be displayed near each wave 130 and an arrow, indicator, or marker may be displayed at the at least one protrusion 142 such that the indicator is moved to another day each time the cap 102 is rotated relative to the receptacle 104.

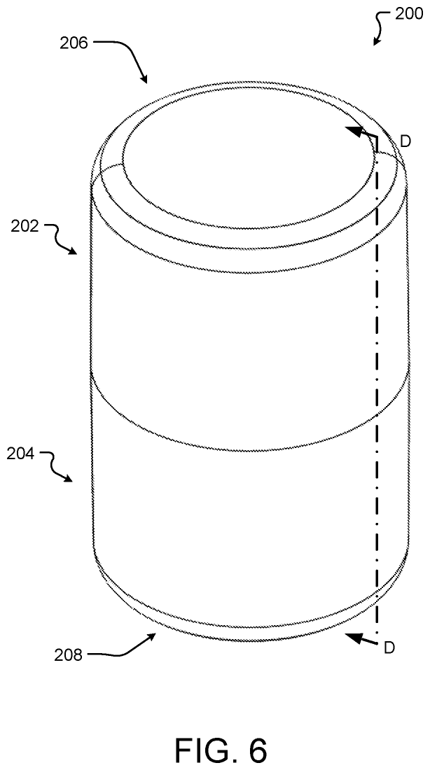

Turning to FIG. 6, an isometric view of a container 200 according to at least one embodiment is shown. The container 200 is generally similar to the container 100 described above. The container 200 is configured to provide feedback when the cap 202 of the container 200 is rotated relative to a receptacle 204 of the container 200. In particular, the feedback is provided when the cap 202 receives a force to move the cap 202 rotationally relative to the receptacle 204. The feedback may be, for example, tactile, audible, and/or visible feedback. As previously described, such feedback may be useful, for example, in providing feedback to a user such as a child to aid the child in remembering to return to the container 200. In the illustrated embodiment, the container 200 (when the cap 202 and the receptacle 204 are coupled) is cylindrical and both a first end 206 and a second end 208 of the container 200 is enclosed. It will be appreciated that in other embodiments, the container 200 may be any shape and/or size. For example, the container 200 may be spherical, rectangular, or oval.

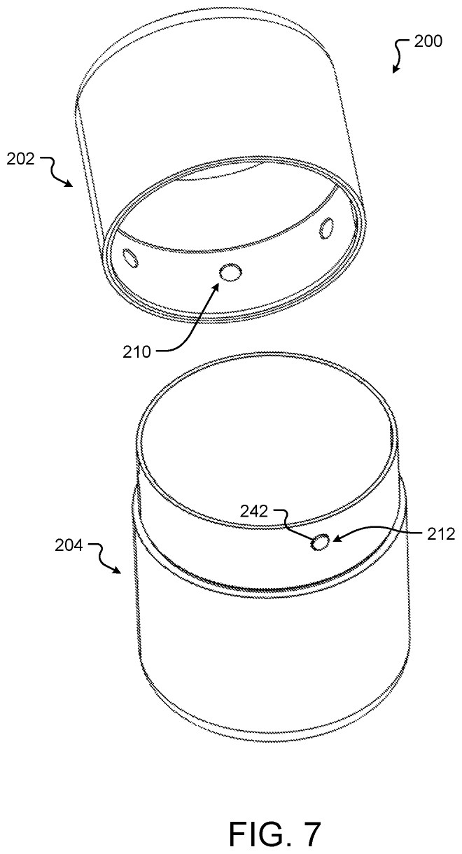

Turning to FIG. 7, the container 200 is shown with the cap 202 and the receptacle 204 separated. The cap 202 and the receptacle 204 may be formed from any material such as, but not limited to, plastic, metal, steel, aluminum, any resilient material, any flexible material, or the like. In some embodiments the cap 202 and the receptacle 204 are formed from the same material. In other embodiments, the cap 202 and the receptacle 204 are formed from different materials. The cap 202 comprises a first feedback feature 210 and the receptacle 204 comprises a second feedback feature 212 configured to engage with the first feedback feature 210. Feedback is provided when the first feedback feature 210 and the second feedback feature 212 engage. It will be appreciated that the cap 202 and/or the receptacle 204 may comprise additional feedback features. Further, the cap 202 and/or the receptacle 204 may provide more than one type of feedback. For example, the first feedback feature 210 and the second feedback feature 212 may provide a tactile and/or audible feedback. In the same example, the cap 202 and/or the receptacle 204 may comprise a third feedback feature configured to provide visual feedback (e.g., a display that changes, a marker on the cap 202 that rotates relative to the receptacle 204, etc.).

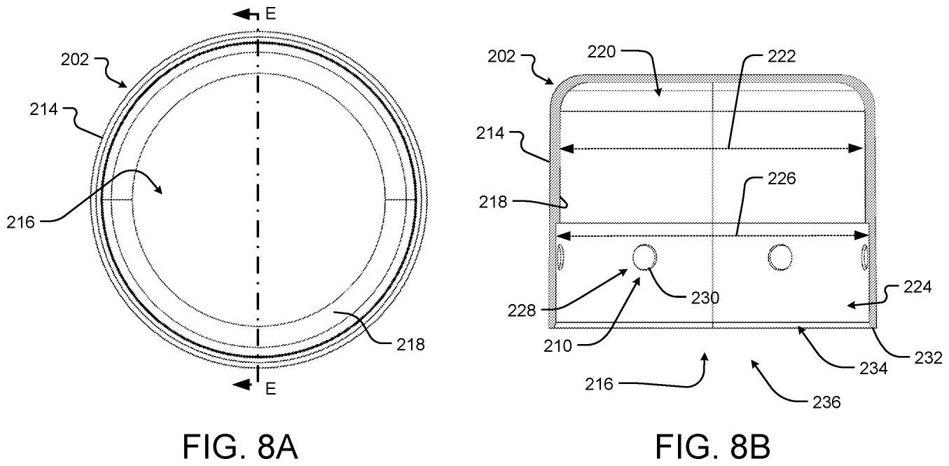

Turning to FIGS. 8A-8B, a top view of the cap 202 and a side cross-sectional side view of the cap 202 taken along line E-E of FIG. 8A are respectively shown. The cap 202 comprises a first body 214 having a first cavity 216. The first body 214 is cylindrical in the illustrated embodiment, though it will be appreciated that the first body 214 may be any shape. The first cavity 216 includes an inner surface 218 and a first circumference. The first cavity 216 also has a first portion 220 having a first diameter 222 and a second portion 224 having a second diameter 226. The first diameter 222 is less than the second diameter 226. The first portion 220 forms a volume by which to receive and/or store items (in combination with the receptacle 204). The second portion 224 is sized to receive a receiver portion 240 of the receptacle 204.

The first feedback feature 210 comprises at least one depression 228 disposed on the inner surface 218 and in the second portion 224. More specifically, the at least one depression 228 may comprise a plurality of depressions 228 positioned along the first circumference. In the illustrated embodiment, the at least one depression 228 comprises seven depressions. It will be appreciated that in some embodiments, the at least one depression 228 comprises more than or less than seven depressions. In the illustrated embodiment, the seven depressions are spaced equidistance around the first circumference. In other embodiments, the seven depressions (or any number of depressions) may not be spaced equidistance around the first circumference and may be spaced anywhere on the cap 202. As shown in the illustrated embodiment, each depression of the at least one depression 228 comprises a circular depression 230. In other embodiments, each depression may comprise a depression of any size or shape including, for example, an oval, a square, a rectangle, a triangle, or the like. It will be appreciated that each depression may be a different size and/or shape than other depressions of the at least one depression 228.

In the illustrated embodiment, the cap 202 includes seven circular depressions 230. It will be appreciated in other embodiments that the cap 202 may include less than or more than seven circular depression 230. As will be described in detail below, the at least one depression 228 (e.g., circular depression 230) is configured to receive a protrusion 242 of the receptacle 204 and movement of the protrusion 242 from a first depression (e.g., a first circular depression 230) to an adjacent depression (e.g., an adjacent circular depression 230) provides feedback to a user. In embodiments where the at least one depression 228 comprises seven depressions, the seven depressions may correlate to seven days of the week.

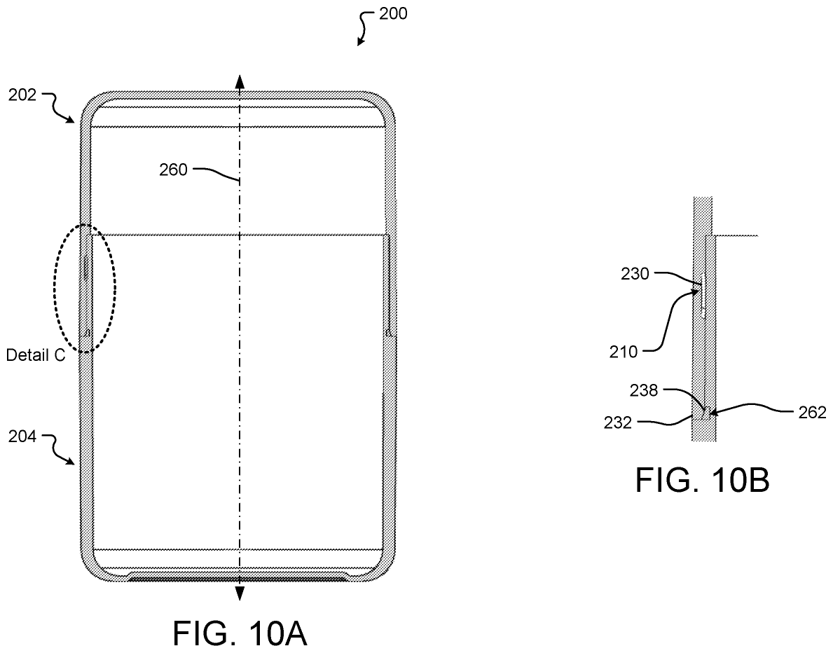

In the illustrated example, the cap 202 may comprise an edge 232 having a countersunk or conical hole 234 at an opening 236 of the first cavity 216. The edge 232 may be configured to seat against, for example, a gasket or an O-ring 238 (visible in FIG. 10B) to form a seal between the receptacle 204 and the cap 202. In some embodiments, the cap 202 and the receptacle 204 may be secured to each other in a press fit (and the gasket or O-ring 238 may form a seal between the receptacle 204 and the cap 202). It will be appreciated that in other embodiments, the cap 202 and the receptacle 204 may be secured to each other using other forms of securement. For example, the cap 202 may comprise at least one cap protrusion (as described with respect to the container 100) disposed on the inner surface 218 and configured to be received by a groove of the receptacle 204. The cap 202 may be secured to the receptacle 204 when the at least one cap protrusion is received by the groove.

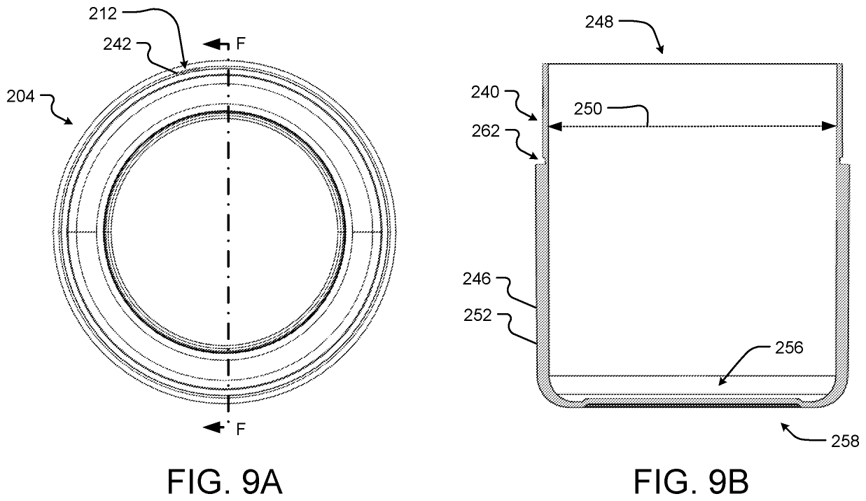

Turning to FIGS. 9A-9B, a top view of the receptacle 204 and a side cross-sectional side view of the receptacle 204 taken along line F-F of FIG. 9A are respectively shown. The receptacle 204 comprises a second body 246 having a second cavity 248. The second body 246 is cylindrical in the illustrated embodiment, though it will be appreciated that the second body 246 may be any shape. The second cavity 248 defines a third diameter 250 substantially equal to the first diameter 222. In other instances, the third diameter 250 may be less than or greater than the first diameter 222. The second cavity 248 and the first cavity 216 are configured to receive and/or store items such as, for example, supplements, medications, or the like.

The second body 246 comprises the receiver portion 240 which is configured to be received by the second portion 224 of the cap 202. The second body 246 also comprises an outer surface 252 defining a second circumference and at least one protrusion 242 (also visible in FIGS. 2, 5A, and 5B) disposed on the outer surface 252. The at least one protrusion 242 is also disposed on the receiver portion 240. As previously described, the at least one protrusion 242 is receivable by the at least one depression 228. The receiver portion 240 also comprises a groove 262 configured to receive the gasket or O-ring 238. In the illustrated embodiment, the second body 246 comprises a raised portion 256 at a bottom 258 of the second body 246. It will be appreciated that in other embodiments, the second body 246 may not include the raised portion 256 and the second body 246 may have a flat surface at the bottom 258, or may have a surface of any shape. In still other embodiments, the second body 246 may include a protrusion and/or the raised portion 256.

Turning to FIGS. 10A-10B, a side cross-sectional side view of the container 200 taken from line D-D shown in FIG. 6 and Detail C of the side cross-sectional side view of the container 200 are respectively shown. More specifically, FIG. 10B illustrates the at least one depression 228 and the edge 232 seated against the gasket or O-ring 238.

The cap 202 and the receptacle 204 are configured to receive a force to move the at least one protrusion 242 from a first depression of the at least one depression 228 to an adjacent depression. More specifically, in embodiments where the at least one depression 228 comprises circular depressions 230 (or depressions of any shape), the at least one protrusion 242 is received by the circular depression 230. To move the at least one protrusion 242 from a first circular depression 230 to a second, adjacent circular depression 230, the cap 202 is rotated around an axis 260 until the at least one protrusion 242 is received in the second, adjacent circular depression 230. A user rotating the cap 202 may receive tactile feedback when the at least one protrusion 242 is received in the second, adjacent circular depression 230. For example, the user may feel resistance when rotating the cap 202 between circular depressions 230 and may no longer feel the resistance when the at least one protrusion 242 is received in the second, adjacent circular depression 230. In some instances, the user may also receive audible feedback when the at least one protrusion 242 is received in the second, adjacent circular depression 230. For example, a “snapping” noise may be heard when the at least one protrusion 242 is received in the second, adjacent circular depression 230. As previously described, such movement of the cap 202 and the receptacle 204 provides feedback to a user such as, for example, a child. The feedback may help the child to remember to return to the container 200 each day, or as needed, for the child's supplement and/or medication. Further, in embodiments where the at least one depression 228 comprises seven circular depressions 230, each circular depression 230 may be associated with a day of the week. In some embodiments, a visual feedback such as, for example, the day of the week may be displayed near each circular depression 230 and an arrow, indicator, or marker may be displayed at the at least one protrusion 242 such that the indicator is moved to another day each time the cap 202 is rotated relative to the receptacle 204.

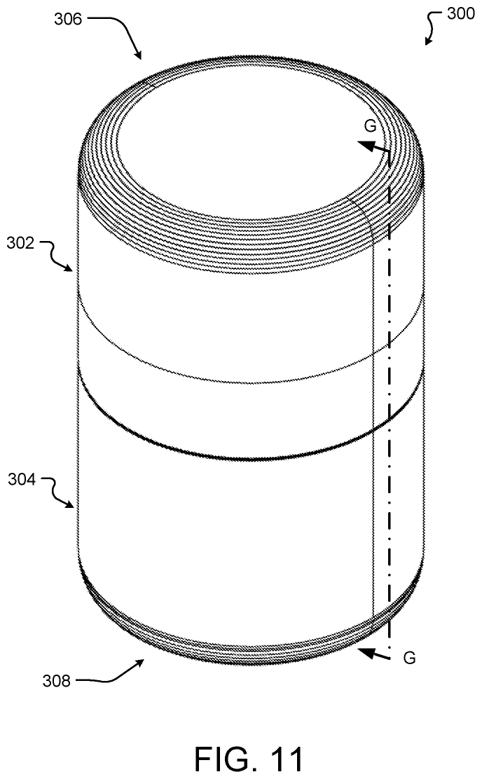

Turning to FIG. 11, an isometric view of a container 300 is shown. The container 300 is similar to the container 100, 200 described above, except that the container 300 does not comprise a first feedback feature or a second feedback feature. In the illustrated embodiment, the container 300 (when the cap 302 and the receptacle 304 are coupled) is cylindrical and both a first end 306 and a second end 308 of the container 300 is enclosed. It will be appreciated that in other embodiments, the container 300 may be any shape and/or size. For example, the container 300 may be spherical, rectangular, or oval.

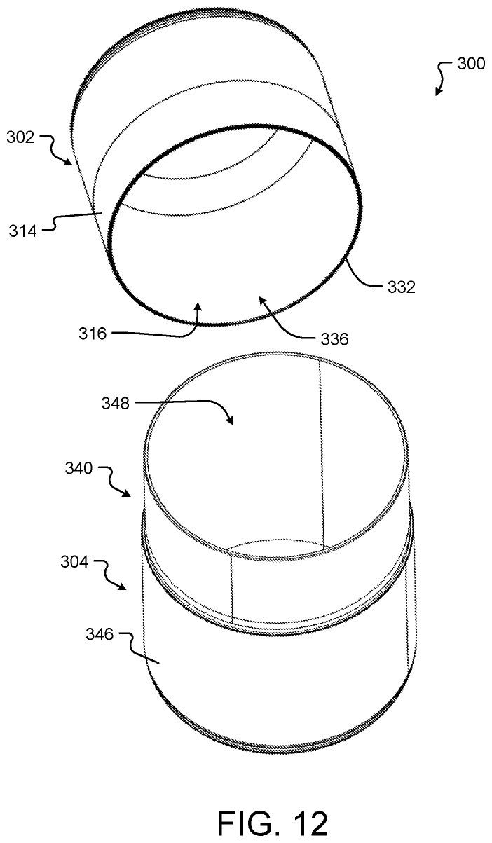

Turning to FIG. 12, the container 300 is shown with the cap 302 and the receptacle 304 separated. The cap 302 and the receptacle 304 may be formed from any material such as, but not limited to, plastic, metal, steel, aluminum, any resilient material, any flexible material, or the like. In some embodiments the cap 302 and the receptacle 304 are formed from the same material. In other embodiments, the cap 302 and the receptacle 304 are formed from different materials.

The cap 302 comprises a first body 314 having a first cavity 316. The first body 314 is cylindrical in the illustrated embodiment, though it will be appreciated that the first body 314 may be any shape. The first cavity 316 forms a volume by which to receive and/or store items (in combination with the receptacle 304).

In the illustrated example, the cap 302 may comprise an edge 332 at an opening 336 of the first cavity 316. The edge 332 may be configured to seat against, for example, a lip 362 of the receptacle 304. In some embodiments, an O-ring, a gasket, or the like may be positioned at the lip 362 to form a seal between the receptacle 304 and the cap 302. In some embodiments, the cap 302 and the receptacle 304 may be secured to each other in a press fit (and the gasket, O-ring, or the like may form a seal between the receptacle 304 and the cap 302). It will be appreciated that in other embodiments, the cap 302 and the receptacle 304 may be secured to each other using other forms of securement. For example, the cap 302 may comprise at least one cap protrusion (as described with respect to the container 100) disposed on an inner surface of the cap 302 and configured to be received by a groove of the receptacle 304. The cap 302 may be secured to the receptacle 304 when the at least one cap protrusion is received by the groove. In another example, the edge 332 may seat against a gasket or an O-ring (as described with respect to the container 200) that is received by a groove of the receptacle 304.

The receptacle 304 comprises a second body 346 having a second cavity 348. The second body 346 is cylindrical in the illustrated embodiment, though it will be appreciated that the second body 346 may be any shape. The second cavity 348 and the first cavity 316 are configured to receive and/or store items such as, for example, supplements, medications, or the like. The second body 346 comprises the receiver portion 340 which is configured to be received by the first cavity 316 of the cap 302.

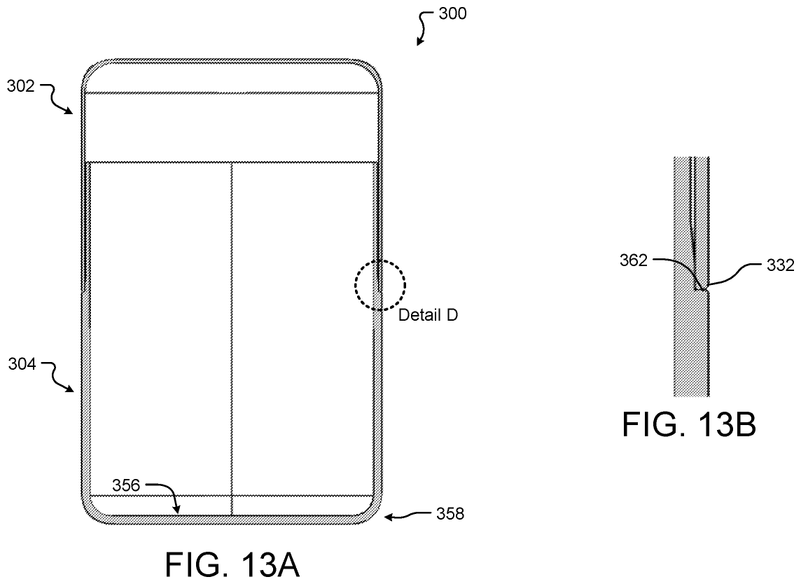

Turning to FIGS. 13A-13B, a side cross-sectional side view of the container 300 taken from line G-G shown in FIG. 1 and Detail D of the side cross-sectional side view of the container 300 are respectively shown. In the illustrated embodiment, the second body 346 comprises a flat surface 356 at a bottom 358 of the second body 346. It will be appreciated that in other embodiments, the second body 346 include a protrusion, a raised portion, or may have a surface of any shape. FIG. 13B, in particular, illustrates the edge 332 seated against the lip 362 of the receptacle 304, thereby enclosing the container 300.

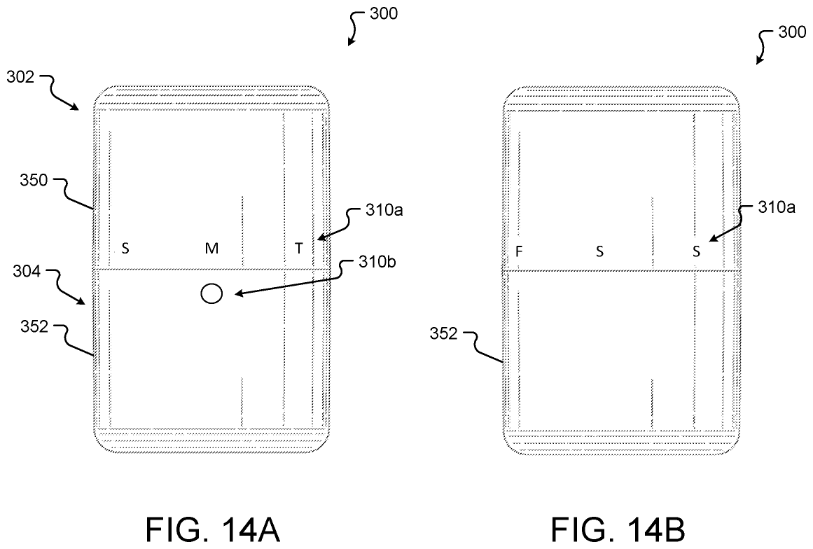

Turning to FIGS. 14A-14B, a front elevation view and a rear elevation view, respectively, of the container 300 are shown. The container 300 may comprise a set of first indicia 310a disposed on an outer surface 350 of the cap 302 and a second indicia 310b disposed on an outer surface 352 of the receptacle 304. The second indicia 310b may align with one of the first set of indicia 310a. The set of first indicia 310a and/or the second indicia 310b may be, for example, laser engraved, printed, painted, or machined onto the outer surfaces 352, 350. In some embodiments, the set of first indicia 310a and/or the second indicia 310b may be raised from or etched into the outer surfaces 352, 350. In other embodiments, the set of first indicia 310a and/or the second indicia 310b may be simply disposed on the outer surfaces 352, 350 (e.g., the set of first indicia 310a and/or the second indica 310b may be smooth).

In the illustrated embodiment, the set of first indicia 310a comprises seven indicia correlating to the days of the week (e.g., “M” for Monday, “T” for Tuesday, “W” for Wednesday (not visible), “T” for Thursday (not visible), “F” for Friday, “S” for Saturday, and “S” for Sunday) and the second indicia 310b comprises a circle. It will be appreciated that the set of first indicia 310a may correlate to any measurement such as, for example, months, hours, days, weeks, years, etc. Similarly, the second indicia 310b may comprise any shape, numbering, or lettering. As previously described, the second indicia 310b may align with one of the first set of indicia 310a. Such alignment may be used to track a first indicia of the set of first indicia 310a. For example, in the illustrated embodiment, the second indicia 310b is aligned with “M.” This may indicate, for example, that a user has not yet used the content(s) of the container 300 for Monday. When the user has used the content(s) of the container 300, the user may then rotate the cap 302 such that the second indicia 310b aligns with, for example, “T.”

It will be appreciated that any container 100, 200, 300 may comprise the set of first indicia 310a and/or the second indicia 310b. In embodiments where feedback is provided, such as the containers 100, 200, the set of first indicia 310a may align with the at least one depression 128, 228 and the second indicia 310b may align with the protrusion 142, 242. For example, in embodiments where the at least one depression 128, 228 comprises seven depressions and the set of first indicia 310a comprises seven letters corresponding to the days of the week, each of the seven depressions may correlate with a corresponding letter. As such, when the cap 102, 202 and/or the receptacle 104, 204 is rotated, the second indica 310b is moved from one of the seven letters to an adjacent letter and the protrusion 142, 242 is moved from one of the seven depressions to an adjacent depression and provides a feedback. As such, the container 100, 200 provides a first feedback (whether tactile, haptic, and/or audible) and a second, visual feedback. This may be useful for a user to remember whether the user has used the content(s) of the container 100, 200 for the day. For example, the first feedback and the second feedback may help a child to remember to take their supplements, probiotics, medication, etc. for each day.

It will be appreciated that the containers 100, 200, 300 may comprise any feature of any container. For example, the receptacle 304 of the container 100 may comprise a flat bottom surface as shown with respect to container 300. In another example, the cap 302 and the receptacle 304 of the container 200 may comprise a cap protrusion and a groove, respectively, as described with respect to container 100.

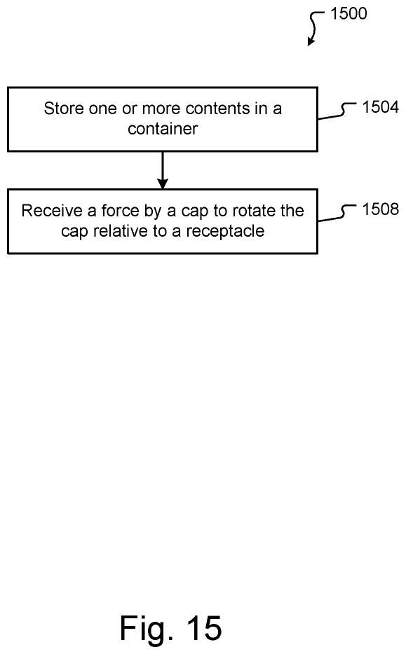

Turning to FIG. 15, a flowchart illustrating a method 1500 of use of a container such as the container 100, 200, 300 is provided.

The method 1500 comprises storing one or more contents in a container (step 1504). The container may be the same as or similar to the container 100, 200, 300. The container may comprise a cap such as the cap 102, 202 comprising a first feedback feature such as the first feedback feature 110, 210 and a receptacle such as the receptacle 104, 204 comprising a second feedback feature 112, 212. The second feedback feature may be configured to engage with the first feedback feature such that the first feedback feature and the second feedback feature provide feedback when engaged. The cap may also comprise a set of first indicia such as the set of first indicia 310a disposed on an outer surface of the cap. In some embodiments, each of the at least one depression aligns with each of the set of first indicia. The receptacle may comprise a second indicia such as the second indicia 310b, which may be aligned with the second feedback feature.

The method 1500 also comprises receiving a force by the cap to rotate the cap relative to the receptacle (step 1508). Rotation of the cap may move the second feedback feature from engagement with one of the at least one depression to engagement with an adjacent one of the at least one depression and simultaneously moves the second indicia from alignment with one of the set of first indicia to an adjacent one of the set of first indicia.

It will be appreciated that the steps 1504 and/or 1508 may be repeated. For example, the step 1508 may be repeated each time an content is removed from the container. In such examples, the set of first indicia may comprise a set of letters corresponding to the days of the week and the second indicia may be a circle. When step 1508 occurs, the circle may move from one letter (indicated one day of the week) to another letter (indicating another day of the week). As such, the method 1500 may be used, for example, to track usage of the contents stored in the container and in some instances, the feedback provided by the container may provide a reminder or audible or physical indicator to a user to help a user to use the contents stored in the container as needed.

The present disclosure encompasses embodiments of the method 1500 that comprise more or fewer steps than those described above, and/or one or more steps that are different than the steps described above.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A container comprising:
a cap comprising a first feedback feature; and
a receptacle comprising a second feedback feature configured to engage with the first feedback feature,
wherein the first feedback feature and the second feedback feature provide feedback when engaged.

2. The container of claim 1, wherein the cap comprises a first body having a first cavity, the first cavity having an inner surface defining a first circumference, wherein the first feedback feature comprises at least one depression disposed on the inner surface.

3. The container of claim 2, wherein the receptacle comprises a second body having a second cavity, the second body having an outer surface defining a second circumference, wherein the second feedback feature comprises at least one protrusion disposed on the outer surface, the at least one protrusion receivable by the at least one depression.

4. The container of claim 2, wherein the at least one depression comprises a plurality of depressions positioned along the first circumference.

5. The container of claim 4, wherein the plurality of depressions comprises at least seven depressions.

6. The container of claim 1, wherein the first body and the second body are each cylindrical.

7. The container of claim 2, wherein each of the at least one depression comprises a wave having a crest and a trough, and wherein the at least one protrusion is received in the crest.

8. The container of claim 2, wherein the first feedback feature further comprises a depression ring, and wherein each wave is connected to an adjacent wave via the depression ring.

9. The container of claim 2, wherein each of the at least one depression comprises a circular depression.

10. The container of claim 3, wherein the cap and the receptacle are configured to receive a force to move the protrusion from a first depression of the at least one depression to an adjacent depression.

11. The container of claim 1, wherein the feedback comprises at least one of tactile feedback or audible feedback.

12. The container of claim 1, wherein the feedback comprises tactile feedback and audible feedback.

13. The container of claim 2, wherein the cap comprises an outer surface and a set of first indicia disposed on the outer surface, wherein the set of first indicia aligns with the at least one depression, and wherein the receptacle comprises an outer surface and a second indicia disposed on the outer surface, and wherein the second indicia aligns with the second feedback feature.

14. A container comprising:
a cap comprising a first feedback feature, the cap comprising a first body having an inner surface and a first circumference, the first feedback feature comprising a plurality of circular depressions positioned on the inner surface along the first circumference; and
a receptacle comprising a second feedback feature configured to engage with the first feedback feature, the receptacle comprising a second body having an outer surface and a second circumference, the second feedback feature comprising a protrusion positioned on the outer surface and along the second circumference,
wherein the first feedback feature and the second feedback feature provide feedback when the protrusion engages one of the plurality of circular depressions.

15. The container of claim 14, wherein the cap and the receptacle are configured to receive a rotational force to move the protrusion from a first circular depression to an adjacent circular depression.

16. The container of claim 15, wherein the plurality of circular depressions comprises seven circular depression.

17. The container of claim 15, wherein the cap comprises a cap protrusion and the receptacle comprises a lip configured to receive the cap protrusion, and wherein the cap and the receptacle are secured to each other when the cap protrusion is received by the lip.

18. A method for tracking comprising:
storing one or more contents in a container comprising a cap and a receptacle, the cap comprising an outer surface, an inner surface, a first feedback feature positioned on the inner surface, and a set of first indicia disposed on the outer surface, the first feedback feature comprising at least one depression, each of the at least one depression aligns with each of the set of first indicia, the receptacle comprising a second feedback feature configured to engage with the first feedback feature and a second indicia, the second feedback feature comprising a protrusion configured to engage one of the at least one depression, the protrusion aligns with the second indicia, wherein the second indicia aligns with one of the set of first indicia; and
receiving a force by the cap to rotate the cap relative to the receptacle, wherein rotation of the cap moves the protrusion from engagement with one of the at least one depression to engagement with an adjacent one of the at least one depression and moves the second indicia from alignment with one of the set of first indicia to an adjacent one of the set of first indicia.

19. The method of claim 18, wherein engagement of the protrusion with the adjacent one of the at least one depression provides feedback.

20. The method of claim 19, wherein the feedback comprises at least one of tactile feedback or audible feedback.
